(19) United States
(12) Patent Application Publication
(10) Pub. No.: US 2014/0250059 A1
(43) Pub. Date: Sep. 4, 2014

(54) Method and Apparatus for Performing Bi-State Editing

(71) Applicant: Anant Gilra, Bangalore (IN)

(72) Inventor: Anant Gilra, Bangalore (IN)

(21) Appl. No.: 12/130,223

(22) Filed: May 30, 2008

(51) Int. Cl. G06F 17/30

(52) U.S. Cl. 707/609; 707/E17.055; 707/821

(57) ABSTRACT

A method, apparatus and computer program product for performing bi-state editing of an image file is presented. An image file is selected for editing, the image file having a plurality of layers. A layer of the plurality of layers is selected, the layer in a first state. The layer is automatically converted to a second state while the first state of the layer is maintained. At least one of the first state of the layer and the second state of the layer is edited. One of the first state of the layer and the second state of the layer is then committed.

### BACKGROUND

The following terminology will be used throughout to describe and refer to various items used in performing bi-state editing. A layer (sometimes referred to as an object) is a component of an image file. An image file can have several (up to hundreds) layers. There may be different types of layers in an image file (for example a content layer, a shape layer, a web layer, etc.). A layer set is a group that can contain multiple layers (objects). A mask is used to work with only a portion of an image. A mask can be a vector mask or a bitmap mask and can be used to work with only a portion of a layer. Bi-state refers to a layer being represented in two states, typically a vector state and a bitmap state.

There are different types of editing applications used for editing image files. A typical image file can contain several layers, each layer being either a bitmap layer or a vector layer. A bitmap layer is sometimes referred to as a raster layer, and a bitmap image is sometimes referred to as a raster image. The term bitmap refers to an image represented as a two dimensional array of brightness values for pixels. The term vector refers to the representation of separate shapes such as lines, polygons and text, and groups of such objects.

One type of image editing application utilizes bitmap-based tools for editing bitmap layers. Another type of image editing application utilizes vector-based tools for editing vector layers. There are other image editing applications that can be used for editing both bitmap and vector layers, and thus utilizes both bitmap and vector tools. However, in this type of image editing applications both tools work independently of each other. If the layer being edited is a bitmap layer, the layer can only be edited with bitmap tools and if the layer being edited is a vector layer, the layer can only be edited with vector tools.

A bitmap layer can be converted to a vector layer, and a vector layer can also be converted to a bitmap layer. To convert a bitmap layer to a vector layer a two-step process is used. First, a marquee selection is made from the selected layer and then a conversion is made from marquee to path which results in a vector layer. A vector layer can be converted to a bitmap layer in a single step wherein the selected vector layer is flattened into a bitmap layer.

### SUMMARY

Conventional mechanisms such as those explained above suffer from a variety of deficiencies. There is no convenient way for a user to use bitmap tools as well as vector tools on the same layer (which could be a bitmap or a vector) and compare and retain the better of the two. There are workarounds, but they take a larger number of steps even if a user were to make modifications with both tools and compare just once. To modify a layer using both tools, the user duplicates the layer, and then converts the duplicate layer to the other state. After making changes to both layers, the user can compare the layers and discard one of the layers. The user is further required to make one of the layers invisible and to make the other layer visible each time the layers are compared. Thus, it takes 5+2n steps in total, where n is the number of swaps performed by the user. This process is labor intensive and time consuming.

In another scenario, a user might start using one set of tools (bitmap or vector but not both) and later on in the editing process, if the user feels the edits are not coming out as expected, the user would then have to undo all the steps, convert the layer to the other state (vector to bitmap or bitmap to vector) and start making changes. The user would have no way to compare the results of one set of edits to a layer state with the results from a set of edits no the other layer state, and no way to iteratively work on bitmap tools and then vector tools and then bitmap again. The same scenario as above holds for vector to bitmap mask conversion and vice versa, which is even more difficult to achieve.

By way of embodiments of the presently described method, apparatus and system for performing bi-state editing, a user is able to work on either of bitmap layers or vector layers using both bitmap and vector tools, compare the results, choose the better and bifurcate or commit the two states any number of times. The combination of vector and bitmap tools on the same object (bitmap/vector) can be used to nullify the inherent limitations of vector/bitmap tools used in isolation. The bi-state process is also applicable to masks.

There are different sets of tools, and therefore different functionalities available, for raster vs. vector art. Instead of having to manually convert back and forth or be limited to one set of tools or the other, the software automatically and transparently does the conversion and therefore does not limit the set of tools available to the user at one time depending on the file type.

The presently disclosed method and apparatus for performing bi-state editing allows the user to experiment with both bitmap and vector tools at the same time on the same object. No one tool is superior to the other and both are important and which tool is used depends on the edit or edits being performed. Sometimes, it so happens that until the user actually tries both tools, the user really doesn't know which of the tools would better suit the user's needs. The user can edit a bitmap with both bitmap and vector tools simultaneously, edit a vector with both bitmap and vector tools simultaneously, bifurcate into two states (bitmap and vector) at any time and start working on both, compare the results of bitmap and vector edits and choose the better of the two, discarding the other. In general the limitations of one of vector/bitmap tools are the strengths of the other. The combination of vector and bitmap tools on the same object can be used to nullify the inherent limitations of these individual tools. The above can be applied to vector masks and bitmap masks as well.

In a particular embodiment of a method for performing bi-state editing, the method includes receiving a file for editing, the file having a plurality of layers. The method further includes receiving a selection of a layer of the plurality of layers, the layer in a first state and receiving an instruction to perform an edit operation on the layer, the edit operation configured to operate on a second state. The method additionally includes converting the layer to the second state while maintaining the first state of the layer. The first state comprises one of a vector state and a bitmap state and the second state comprises one of a bitmap state and a vector state and the second state is a different state than the first state. As a result the user now has a vector state of the layer and a bitmap state of the layer. Further, the method includes performing the edit operation on at least one of the first state of the layer and the second state of the layer. The editing at least one of the first state of the layer and the second state of the layer comprises editing with one of a bitmap tool and a vector tool, wherein the editing with one of a bitmap tool and a vector tool is performed on a per layer basis. The method also includes committing one of the first state of the layer and the second state of the layer. The committing one of the first state of the layer and the second state of the layer further comprises disregarding the state not being committed. The method may further include closing the file, the closing the file committing all layers of the file. The user can perform multiple sets of edits to a single layer, and can also perform sets of edits on multiple layers of an image file.

Other embodiments include a computer readable medium having computer readable code thereon for performing bi-state editing. The computer readable medium includes instructions for receiving a file for editing, the file having a plurality of layers. The computer readable medium further includes instructions for receiving a selection of a layer of the plurality of layers, the layer in a first state and receiving an instruction to perform an edit operation on the layer, the edit operation configured to operate on a second state. The computer readable medium additionally includes instructions for converting the layer to the second state while maintaining the first state of the layer. Further, the computer readable medium includes instructions for performing the edit operation on at least one of the first state of the layer and the second state of the layer. The computer readable medium also includes instructions for committing one of the first state of the layer and the second state of the layer. The computer readable medium may further include instructions for closing the file, the closing the file committing all layers of the file.

Still other embodiments include a computerized device, configured to process all the method operations disclosed herein as embodiments. In such embodiments, the computerized device includes a memory system, a processor (including one or more of a Central Processing Unit (CPU) and a Graphics Processing Unit (GPU)), communications interface in an interconnection mechanism connecting these components. The memory system is encoded with a process that performs bi-state editing as explained herein that when performed (e.g. when executing) on the processor, operates as explained herein within the computerized device to perform all of the method embodiments and operations explained herein as embodiments. Thus any computerized device that performs or is programmed to perform up processing explained herein is an embodiment.

Other arrangements of embodiments of the disclosure that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations performing bi-state editing as explained herein. The computer program logic, when executed on at least one processor with a computing system, causes the processor to perform the operations (e.g., the methods) indicated herein as embodiments of the disclosure. Such arrangements are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein. Software processes that operate in a collection of computerized devices, such as in a group of data communications devices or other entities can also provide the system of the disclosure. The system can be distributed between many software processes on several data communications devices, or all processes could run on a small set of dedicated computers, or on one computer alone.

It is to be understood that the embodiments can be embodied strictly as a software program, as software and hardware, or as hardware and/or circuitry alone, such as within a data communications device. The features of the disclosure, as explained herein, may be employed in data communications devices and/or software systems for such devices such as those manufactured by Adobe Systems Incorporated of San Jose, Calif.

Note that each of the different features, techniques, configurations, etc. discussed in this disclosure can be executed independently or in combination. Accordingly, the present disclosure can be embodied and viewed in many different ways. Also, note that this summary section herein does not specify every embodiment and/or incrementally novel aspect of the present disclosure. Instead, this summary only provides a preliminary discussion of different embodiments and corresponding points of novelty over conventional techniques. For additional details, elements, and/or possible perspectives (permutations), the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the disclosure, as illustrated in the accompanying drawings in which like reference characters refer to the same parts throughout the different views. The drawings are not necessarily to scale, emphasis instead being placed upon illustrating the principles of the disclosure.

FIGS. 1A and 1B depict screen shots of a Graphical User Interface (GUI) showing how a user can perform bi-state editing;

FIG. 2 is a diagram of an example workflow using bi-state editing;

FIGS. 3A and 3B depict a flow diagram of a particular embodiment of a method for performing bi-state editing; and

FIG. 4 illustrates an example computer system architecture for a computer system that performs bi-state editing.

### DETAILED DESCRIPTION

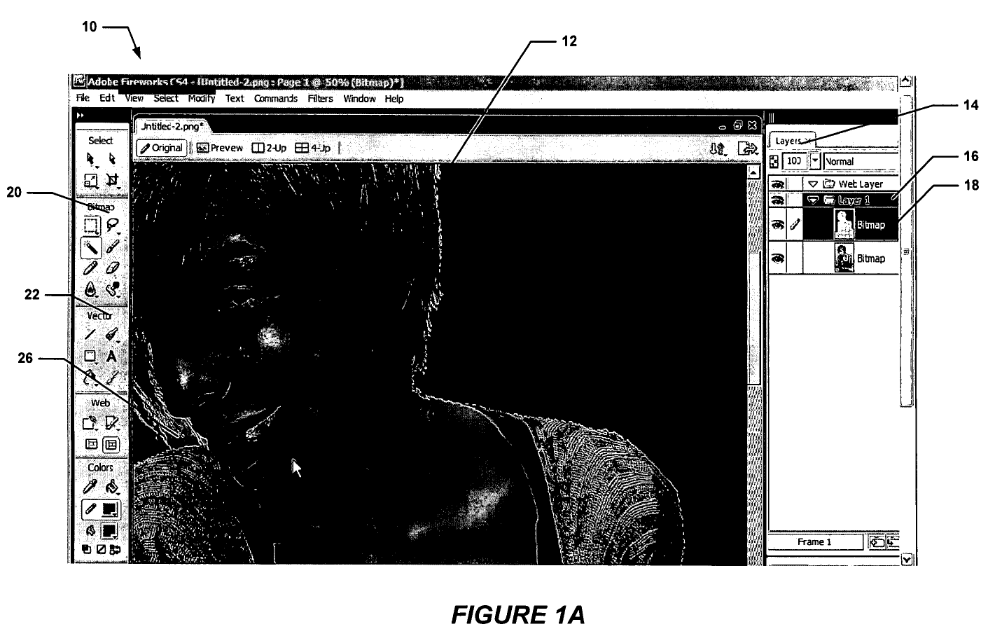

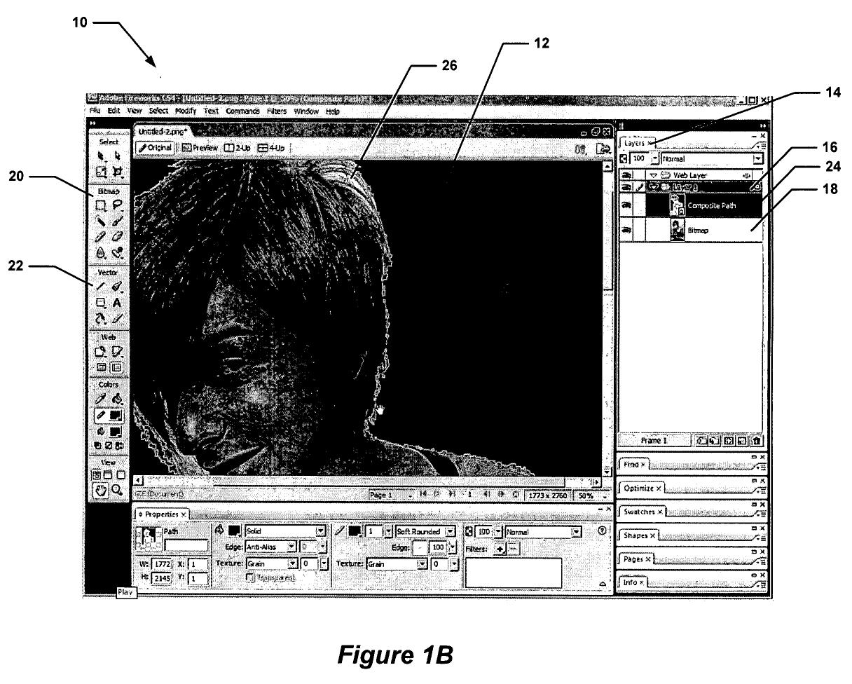

Referring now to FIGS. 1A and 1B, a screen shot of a Graphical User Interface (GUI) 10 is shown wherein a user is able to perform bi-state editing in accordance with embodiments of the present disclosure. GUI 10 in this example shows an image 12 being edited. As shown on the right hand side, a LAYERS tab 14 is shown along with a listing of different layers. In this example a single layer 14 (layer 1) is shown. It should be appreciated that an image file can include several (up to hundreds) layers, and that only a single layer is shown here for explanation purposes.

Shown on the left side of GUI 10 is an area 20 containing icons for a variety of bitmap editing tools. Also shown is area 22 containing a variety of vector tools. A user can thus select an image file for editing and select a particular layer of the image file to work on. In this example, layer 1 has been selected as shown by dropdown menu 16.

The background 25 of the image 12 is being edited with bitmap and/or vector tools, to get a better cutout (in general this is called creating a mask), and remove the white portions 26 which can be seen through the person's hair. The user wants to remove the white portion 26 to generate a finer cutout since the user desires to only see background or the hair or the person, and not the white. Later, the background can be replaced by some other color or even some other background, and it will appear like one can see the background from between the hair strands to give a realistic effect.

Referring to FIG. 1A, the user has selected the bitmap state of the layer to work on, and is using a bitmap tool selected from bitmap area 20 to do so. In this example, the file started out as a bitmap file having a plurality of bitmap layers. In one embodiment the user simply selects the bitmap tool to edit the bitmap version, while in another embodiment the file is automatically converted to raster and vector before the selection.

Referring now to FIG. 1B, the user has clicked on thumbnail 24 to swap to the vector state of the layer. This may be done as a result of the action or alternately, both the vector and the bitmap version are provided before the selection by the user. The vector state is indicated by tool icon 28 shown on thumbnail 24. The tool icon is not shown on thumbnail 24 when the user is using bitmap tools on the bitmap state of the layer. Thus the same thumbnail is used for both states, and there is only one layer in the layers panel at all the times for the bi-state.

The user can select various tools from area 22 for performing edits on the vector layer of the image. For example, the user may not like the white area 26 between pieces of hair of the person in the image, and desire to remove the white section 26 such that whatever background is used, the backgrounds would also show between the pieces of hair of the person in the image 12.

In one example use, different edits can be made with both bitmap tools on the bitmap state of the layer and with vector tools on the vector state of the layer, and a determination is made regarding which set of edits to keep. Additionally, the bitmap layer can be modified with bitmap tools to get to a certain point, the bitmap state is then committed, then changes can be made to the vector state of the latest version of the layer using vector tools to get to an optimal version of the layer.

Once the user has completed the edits, the user can review each layer state and determine which layer state is preferred. The user can then commit one of the layers states while disregarding the other layer state. The user can repeat this process multiple time for the same layer, and can perform the same process on multiple layers, one layer at a time. Closing the file would commit all layers in one step. However, the states may be stored in the file format too so they can be finalized and worked upon later, or maybe committed individually or in totality through contextual menu's or other GUI gestures, whenever the user feels the file has been finalized and doesn't desire to further increase the file size.

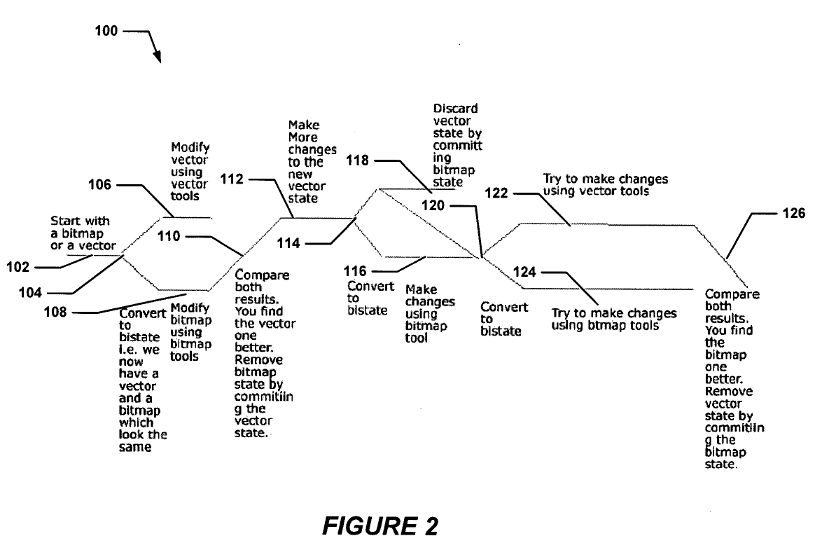

Referring now to FIG. 2, an example work flow diagram 10 is shown. As shown at point 102, the user starts with a bitmap layer or a vector layer. At point 104 of workflow 100, the user converts the selected vector layer or bitmap layer to bi-state. As a result, there are now both bitmap states and vector states of the same layer. Preferably this is accomplished with a simple GUI gesture as would be known by one of ordinary skill in the art.

The GUI gestures to used to perform the conversion to bi-state, the swapping between states and the committing of a state could be realized by any type of GUI item including, but not limited to the following.

Menu items or context menu items applied on one layer. Once the user selects a layer, the menu items are then made available for the user to utilize.

The GUI gesture could be realized as a click or double click on a thumbnail. The thumbnail could have an icon so that one can distinguish between the two states, e.g.: a first style icon for the vector state and no icon in the bitmap state. The thumbnail could have another icon to show that the bi-state is active, and either no icon or a disabled icon to show that the bi-state is inactive. These icons can be displayed in any of the corners of the layer thumbnail.

The GUI gesture could also be realized as a click on some icon (like eye/lock icon) on the layer panel to change state. This icon would represent at least two states—vector and bitmap and optionally two more states to that one of the states has been frozen, and the other is lost.

Another important GUI to swap states could be automatic swapping i.e. when the user is in a bitmap state and selects a vector tool. Then the user is warned (via a dialog or a warning message in a message bar which is placed at one corner or anywhere else in the application) that the state would be changed. There could also be a configuration that has the preference for automatic changing of states with no prompting. If the user accepts that or has the preference set to no prompts, selecting the vector tool and trying to apply a vector only operation on a bitmap would automatically convert the bitmap to vector and vice versa. There are some operations (like rotation, scaling, etc.) which can be done in both states. In such cases, the state won't be auto-changed.

The GUI gesture could also require selection from menu items or context menu items applied on selection (i.e., multiple layers at the same time). In this case, the user would swap to the other state. The GUI gesture could further include the use of short cut keys, or the double clicking on the element/object on the canvas to get the other counterpart.

Referring back to FIG. 2, as shown at points 106 and 108 respectively, the user can use bitmap tools to work on the bitmap state and/or use vector tools to work on the vector state. At point 110, the user can compare the results of the edits. This can also be accomplished by way of a GUI gesture (such as those described above). The user then determines which state to keep and commits that state. The other state is disregarded. This results in either a bitmap layer or a vector layer. The resulting layer can be a different state than the layer the user began with. For example, if the user began with a bitmap layer, the end result could be a vector layer. Similarly, if the user began with a vector layer, the end result could be a bitmap layer.

At point 112 of work flow diagram 100, the user has decided to perform more edits on the newly created vector layer. At point 114 the vector layer is automatically converted to bi-state so that there is now a vector layer state and a bitmap layer state. At point 116 the user makes changes the bitmap layer state using a bitmap tool. At point 118, after editing using the bitmap tools, the user commits the bitmap state, thereby discarding the vector state. At point 120 the new bitmap state is converted to bi-state, producing a bitmap layer state and a vector layer state. The user then makes changes to the vector state using vector tools and at point 124 the user also makes changes to the bitmap layer state using bitmap tools. At point 126 the user compares the resulting states and determines that the bitmap layer state is the better state. The user commits the bitmap state and removes the vector state. In such a workflow, the user is able to use both bitmap and vector tools on different layers and to switch between bitmap and vector states of a layer to provide a desired final layer in a much more efficient manner.

Closing the file commits all the layers. However, the states may be stored in the file format also. Additionally, the states may be committed individually or in totality through contextual menus or other GUI gestures, whenever the user determines he or she has finalized the file and doesn't desire to increase the file size. As in any other feature, at any point of time, the user can undo to any of the previous steps. This bi-state concept may not be applicable on some layers like adjustment layers and such layers cannot be converted to bi-state. In some embodiments, the layer names for both states could be different.

While converting a vector to a bitmap and vice versa, the layer effects, strokes, fills and other attributes can be temporarily disabled and after the conversion is done, added back. This would allow for lossless conversion between the two states.

As described above, the user is able at any time to select a layer, edit the layer, convert the layer to bi-state, edit either or both of the states, compare the states, commit one of the states, and continue editing either the same layer or another layer.

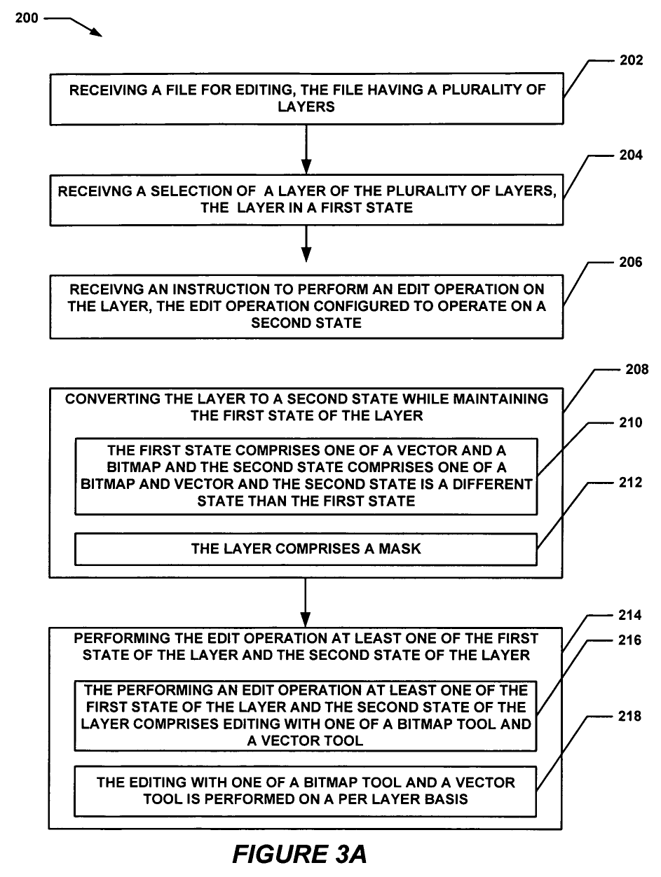

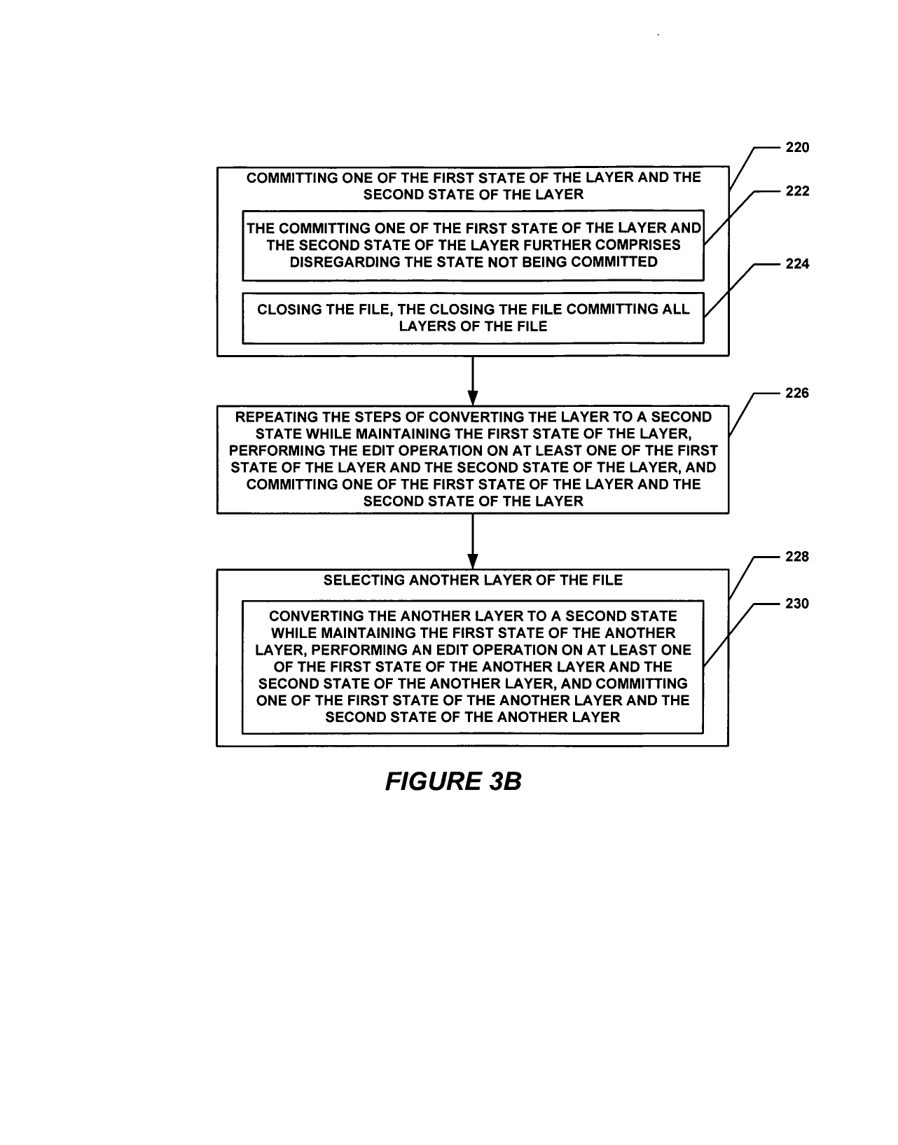

A flow diagram of a particular embodiment of the presently disclosed method is depicted in FIGS. 3A and 3B. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present disclosure. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the disclosure. Thus, unless otherwise stated the steps described below are unordered meaning that, when possible, the steps can be performed in any convenient or desirable order.

Referring now to FIGS. 3A and 3B, a particular embodiment of a method 200 for performing bi-state editing is shown. Method 200 begins with processing block 202, which discloses receiving a file for editing, the file having a plurality of layers. A typical image file may have several, up to hundreds, of layers.

Processing block 204 states receiving a selection of a layer of the plurality of layers, the layer in a first state. Processing block 206 recites receiving an instruction to perform an edit operation on the layer, the edit operation configured to operate on a second state.

Processing block 208 discloses converting the layer to a second state while maintaining the first state of the layer. This is referred to as bi-state as two distinct states exist for the layer. As shown in processing block 210 the first state comprises one of a vector and a bitmap and the second state comprises one of a bitmap and vector and the second state is a different state than the first state. Converting the layer thus takes a bitmap layer and produces a corresponding vector layer, or takes the vector layer and produces a corresponding bitmap layer. As shown in processing block 212 the layer may comprise a mask. A mask is only a portion of a layer. One could have bi-states on both layer and its mask at the same time, thus leading to four possible combinations, two each in layer and mask.

Processing continues with processing block 214, which discloses performing the edit operation on at least one of the first state of the layer and the second state of the layer. Processing block 216 states the editing at least one of the first state of the layer and the second state of the layer comprises editing with one of a bitmap tool and a vector tool. A bitmap layer may be edited with a bitmap tool and a vector layer may be edited with a vector tool. As shown in processing block 218 the editing with one of a bitmap tool and a vector tool is performed on a per layer basis.

Processing block 220 recites committing one of the first state of the layer and the second state of the layer. Once the user is satisfied with the changes, the user commits the layer. As shown in processing block 222 the committing one of the first state of the layer and the second state of the layer further comprises disregarding the state not being committed. Thus if the user commits the bitmap state for the layer, the vector state is disregarded, and if the user commits the vector state of the layer, the bitmap state is disregarded. This is used to save memory and storage space for the image file. Processing block 224 discloses closing the file, the closing the file committing all layers of the file. In some scenarios it may be desirable to maintain both states of a layer and to store both states upon the committing of a layer or upon the closing of the file. This may cause an increase in the file size and the concomitant storage required to store the file.

As shown in processing block 226, in certain embodiments it may be desirable to repeat the steps of converting the layer to a second state while maintaining the first state of the layer, performing the edit operation on at least one of the first state of the layer and the second state of the layer, and committing one of the first state of the layer and the second state of the layer. In this manner, the same layer can be edited by both bitmap tools and vector tools repeatedly to achieve the desired final state of the layer. This permits multiple sets of edits using different tools to be performed on the same layer.

Processing block 228 states selecting another layer of the image file. Once one layer of the image file has been edited, the user may desire to edit another layer of the same image file. As recited in processing block 230 the operation on the newly selected layer may include converting the another layer to a second state while maintaining the first state of the another layer, editing at least one of the first state of the another layer and the second state of the another layer and committing one of the first state of the another layer and the second state of the another layer. The user is thus able to edit multiple layers of the same file in the same manner.

Preview of the other (invisible) state could also be shown in a preview panel which could be docked, made visible/invisible, resized, repositioned etc. and would behave like any other panel.

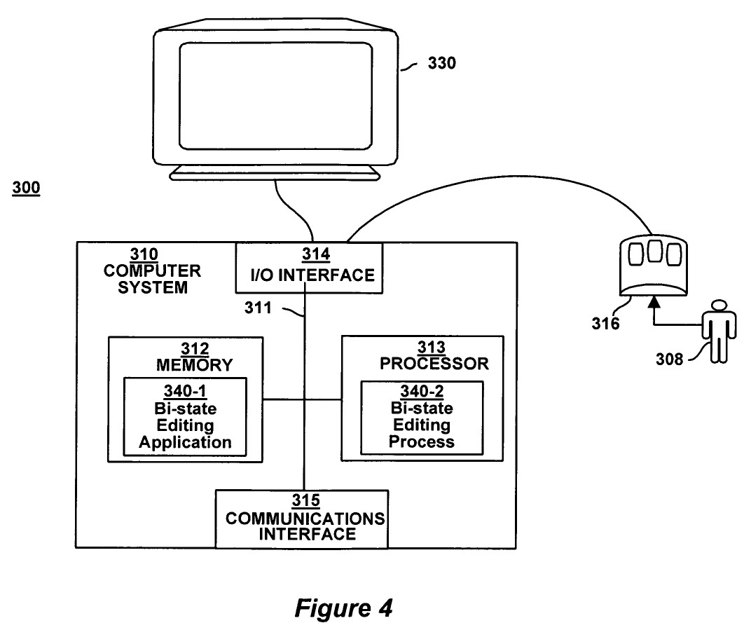

FIG. 4 is a block diagram illustrating an example computer system 300 for implementing bi-state editing function 340 and/or other related processes to carry out the different functionality as described herein.

As shown, computer system 300 of the present example includes an interconnect 311 that couples a memory system 312 and a processor 313 an input/output interface 314, and a communications interface 315.

A user 308 is able to interact and execute the application by way of a GUI displayed on display 300 and through the use of an input device 316, such as a mouse, trackball, keyboard or the like.

As shown, memory system 312 is encoded with bi-state editing application 340-1. Bi-state editing application 340-1 can be embodied as software code such as data and/or logic instructions (e.g., code stored in the memory or on another computer readable medium such as a disk) that support functionality according to different embodiments described herein.

During operation, processor 313 of computer system 300 accesses memory system 312 via the interconnect 311 in order to launch, run, execute, interpret or otherwise perform the logic instructions of the bi-state editing application 340-1. Execution of bi-state editing application 340-1 produces processing functionality in bi-state editing process 340-2. In other words, the bi-state editing process 340-2 represents one or more portions of the bi-state editing application 340-1 (or the entire application) performing within or upon the processor 313 (one or more of a CPU and/or a GPU) in the computer system 300.

It should be noted that, in addition to the bi-state editing process 340-2, embodiments herein include the bi-state editing application 340-1 itself (i.e., the un-executed or non-performing logic instructions and/or data). The bi-state editing application 340-1 can be stored on a computer readable medium such as a floppy disk, hard disk, or optical medium. The bi-state editing application 340-1 can also be stored in a memory type system such as in firmware, read only memory (ROM), or, as in this example, as executable code within the memory system 312 (e.g., within Random Access Memory or RAM).

In addition to these embodiments, it should also be noted that other embodiments herein include the execution of bi-state editing application 340-1 in processor 313 as the bi-state editing process 340-2. Those skilled in the art will understand that the computer system 300 can include other processes and/or software and hardware components, such as an operating system that controls allocation and use of hardware resources associated with the computer system 300.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the disclosure it will now become apparent to those of ordinary skill in the art that other embodiments incorporating these concepts may be used. Additionally, the software may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the embodiments should not be limited to the described embodiments but rather should be limited only by the spirit and scope of the appended claims.

1. A computer implemented method comprising:
receiving a file for editing, said file having a plurality of layers;
receiving a selection of a layer of said plurality of layers, said layer in a first state;
receiving an instruction to perform an edit operation on the layer, the edit operation configured to operate on a second state;
converting said layer to a second state while maintaining said first state of said layer, said first state and said second state configured to be edited substantially simultaneously and independently of the other;
receiving a modification of at least one of said first state of said layer or said second state of said layer; and
committing one of said first state of said layer and said second state of said layer.

2. The method of claim 1 wherein said first state comprises one of a vector and a bitmap and wherein said second state comprises one of a bitmap and vector and wherein said second state is a different state than said first state.

3. The method of claim 1 wherein said committing one of said first state of said layer and said second state of said layer further comprises discarding the state not being committed.

4. The method of claim 1 wherein said receiving a modification of at least one of said first state of said layer or said second state of said layer comprises editing with one of a bitmap tool and a vector tool.

5. The method of claim 4 wherein said receiving a modification operation with one of a bitmap tool and a vector tool is performed on a per layer basis.

6. The method of claim 1 further comprising closing said file, said closing said file committing all layers of said file.

7. The method of claim 1 further comprising repeating said steps of converting said layer to a second state while maintaining said first state of said layer, receiving a modification of at least one of said first state of said layer or said second state of said layer, and committing one of said first state of said layer and said second state of said layer.

8. The method of claim 1 further comprising converting from one state to the other state upon selection of a tool for said other state.

9. The method of claim 1 further comprising selecting a mask and converting said mask to bi-state.

10. The method of claim 1 further comprising selecting another layer of said file.

11. The method of claim 10 further comprising:
converting said another layer to a second state while maintaining said first state of said another layer;
receiving a modification of at least one of said first state of said another layer and said second state of said another layer; and
committing one of said first state of said another layer and said second state of said another layer.

12. A non-transitory computer readable medium having computer readable code thereon for performing bi-state editing, the medium comprising:
instructions for receiving a file for editing, said file having a plurality of layers;
instructions for receiving a selection of a layer of said plurality of layers, said layer in a first state;
instructions for receiving an instruction to perform an edit operation on the layer, the edit operation configured to operate on a second state;
instructions for converting said layer to the second state while maintaining said first state of said layer, said first state and said second state configured to be edited substantially simultaneously and independently of the other;
instructions for receiving a modification of at least one of said first state of said layer or said second state of said layer; and
instructions for committing one of said first state of said layer and said second state of said layer.

13. The non-transitory computer readable medium of claim 12 further comprising instructions wherein said first state comprises one of a vector and a bitmap and wherein said second state comprises one of a bitmap and vector and wherein said second state is a different state than said first state.

14. The non-transitory computer readable medium of claim 12 wherein said instructions for committing one of said first state of said layer and said second state of said layer further comprises discarding the state not being committed.

15. The non-transitory computer readable medium of claim 12 wherein said instructions for receiving a modification of at least one of said first state of said layer and said second state of said layer comprises editing with one of a bitmap tool and a vector tool.

16. The non-transitory computer readable medium of claim 15 wherein said instructions for receiving a modification with one of a bitmap tool and a vector tool are performed on a per layer basis.

17. The non-transitory computer readable medium of claim 12 further comprising instructions for closing said file, said closing said file committing all layers of said file.

18. The non-transitory computer readable medium of claim 12 further comprising instructions for repeating said steps of converting said layer to a second state while maintaining said first state of said layer, receiving a modification of at least one of said first state of said layer and said second state of said layer, and committing one of said first state of said layer and said second state of said layer.

19. The non-transitory computer readable medium of claim 12 further comprising instructions for converting from one state to the other state upon selection of a tool for said other state.

20. The non-transitory computer readable medium of claim 12 further comprising instructions for selecting a mask and converting said mask to bi-state.

21. The non-transitory computer readable medium of claim 12 further comprising instructions for selecting another layer of said file.

22. The non-transitory computer readable medium of claim 21 further comprising:
instructions for converting said another layer to a second state while maintaining said first state of said another layer;
instructions for receiving a modification of at least one of said first state of said another layer and said second state of said another layer; and
instructions for committing one of said first state of said another layer and said second state of said another layer.

23. A computer system comprising:
a memory;
a processor;
an interconnection mechanism coupling the memory and the processor; and
wherein the memory is encoded with an application providing bi-state editing, that when performed on the processor, provides a process for processing information, the process causing the computer system to perform the operations of:
receiving a file for editing, said file having a plurality of layers;
receiving a selection of a layer of said plurality of layers, said layer in a first state;
receiving an instruction to perform an edit operation on the layer, the edit operation configured to operate on a second state;
converting said layer to the second state while maintaining said first state of said layer, said first state and said second state configured to be edited substantially simultaneously and independently of the other;
receiving a modification of at least one of said first state of said layer or said second state of said layer; and
committing one of said first state of said layer and said second state of said layer.

24. The computer system of claim 23 wherein said first state comprises one of a vector and a bitmap and wherein said second state comprises one of a bitmap and vector and wherein said second state is a different state than said first state.

25. The computer system of claim 23 wherein said committing one of said first state of said layer and said second state of said layer further comprises discarding the state not being committed.
